(19) United States
(12) Patent Application Publication
(10) Pub. No.: US 2005/0115940 A1
(43) Pub. Date: Jun. 2, 2005

(54) Method for controlling laser beam machine and laser beam machine

(75) Inventors: Naohisa Matsushita, Kawasaki (JP); Susumu Iida, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 10/994,635

(22) Filed: Nov. 23, 2004

(30) Foreign Application Priority Data
Dec. 2, 2003 (JP) 2003-403345

(51) Int. Cl. B23K 26/02

(52) U.S. Cl. 219/121.83; 219/121.62

(57) ABSTRACT

A laser beam machine and a laser beam machine capable of monitoring the effective energy of a laser beam oscillator, with which an object to be machined is irradiated, and the state of oscillation without affecting the properties of a laser beam, is disclosed. A laser beam machine comprises: a laser beam oscillator; a laser beam transmission path; a collimator lens; a machining condenser lens; at least one optical detection sensor provided along the laser beam transmission path; and an arithmetic control section for receiving the output of the optical detection sensor and performing a predetermined process to obtain the characteristic of a laser beam.

### BACKGROUND OF THE INVENTION

The present invention relates to a method for controlling a laser beam machine and to a laser beam machine.

Laser beam machining is widely used in various fields of such as drilling, cutting, welding and thermal treatment of various materials, because non-contact, high-speed, and high-quality machining is possible. Another advantage is that the above-mentioned various kinds of machining can be performed by a single laser beam oscillator only by changing the laser beam oscillation conditions.

However, such enormous flexibility brings about the possibility of a danger that the quality of machining may suffer from changes in the laser beam oscillation conditions and the irradiation conditions for an object to be machined, for some reason. Therefore, maintaining the quality of machining is a problem.

Conventional techniques relating to a laser beam machine include, for example, a technique disclosed in Japanese Unexamined Patent Publication (Kokai) No. 2002-336985, which allows the movement of a light projection head and, at the same time, guides an optical fiber while preventing the optical fiber from interfering with work, a jig, etc., in a laser beam machine that guides a laser beam to the light projection head through the optical fiber. Japanese Unexamined Patent Publication (Kokai) No. 2002-307180 discloses a technique that moves a lens in accordance with the progress of machining by arranging a focal distance varying means composed of a lens and a lens moving means between an aperture and an fθ lens and utilizing the change in the position of the aperture viewed from the fθ lens. Moreover, Japanese Unexamined Patent Publication (Kokai) No. 2002-254189 discloses a technique that widens the range of the machinable plate thickness by providing a plurality of laser beam oscillators on a single laser beam machine.

In order to prevent the occurrence of trouble caused by a change in the quality of machining depending of the state of laser beam oscillation and the state of irradiation energy, it is necessary to monitor, at all times, the state of laser beam oscillation and the quality of machining. Particularly, in assembling machines and working machines that incorporate a laser beam oscillator, as automatic machines, a numerical control or a control of the laser irradiation conditions or the turning on/off of the irradiation based on electric signals from a control device such as a personal computer and a sequencer is performed. Because of this, it is necessary to automatically monitor whether the laser beam oscillator side operates in accordance with the specified conditions.

In the case of a laser beam machine, a laser beam from a laser beam oscillator is transmitted through an optical fiber, reflected by a mirror, magnified or reduced by a lens, etc., and thus various optical members are used until the laser beam reaches an object to be machined. Moreover, a shutter-mechanism is employed in order to ensure the safety of the human body and machinery. In such a configuration, a problem may be brought about in that an object cannot be machined if some optical members are broken during operation or the characteristics are degraded, and this will considerably affect the quality of machining.

Conventionally, various methods are employed for detecting the characteristics of a laser beam. FIG. 1 is a diagram showing the conventional principles of detection of a laser beam. A well known method is such one in which a half mirror 2 having characteristics of slightly reflecting a laser beam 1 is arranged inside a laser beam oscillator and the reflected beam is detected by an optical detection sensor 3. The method shown in FIG. 1 is one in which the output energy of a laser beam and the shape and time of an oscillation pulse are monitored by receiving the output from the optical detection sensor 3.

### SUMMARY OF THE INVENTION

In the conventional method, however, it is necessary to interpose optical components in an optical path (an optical transmission path), therefore, problems are brought about in that the structure of the apparatus becomes complex, the characteristics of a laser beam vary each time the laser beam is reflected by an optical component or the laser beam passes through an optical component, etc. Because of this, it is normal to perform monitoring only at the minimally required positions. Generally, as described above, monitoring is performed only at the inside of a laser beam oscillator, in most cases, and it has been almost impossible to monitor whether an object to be machined is irradiated with a laser beam, or to monitor the change in the effective irradiation energy, with which the object to be machined is actually irradiated in the case where some optical component is damaged in an optical transmission path.

The present invention has been developed with the above-mentioned problems being taken into account and an object of the present invention is to provide a method for controlling a laser beam machine and a laser beam machine capable of monitoring the effective energy of a laser beam oscillator, with which an object to be machined is irradiated, and the state of oscillation, without affecting the properties of a laser beam, and further, another object is to provide a method for controlling a laser beam machine and a laser beam machine capable of maintaining the conditions of the effective energy, with which an object to be machined is irradiated, and of automatically detecting and indicating a situation in which maintenance is necessary.

In the method for controlling a laser beam machine according to the present invention, at least one optical detection sensor is arranged along a laser beam transmission path, a scattered beam scattered from the laser beam transmission path is detected by the optical detection sensor, and thus the characteristics of a laser beam are obtained by receiving the output of the optical detection sensor.

The laser beam machine according to the present invention comprises: a laser beam oscillator for producing a laser beam; a laser beam transmission path for transmitting the laser beam produced by the laser beam oscillator; a collimator lens for receiving laser beams emitted from the laser beam transmission path to obtain parallel laser beams; a machining condenser lens for receiving the output of the collimator lens to gather laser beams on an object to be machined; at least one optical detection sensor provided along the laser beam transmission path; and an arithmetic control section for receiving the output of the optical detection sensor and performing a predetermined process to obtain the characteristic of a laser beam.

According to the present invention, the configuration is designed so that the scattered beam scattered from the laser beam transmission path can be detected, therefore, it is possible to detect the state of the laser beam by means of the optical detection sensor without affecting the properties of the laser beam. Therefore, according to the present invention, it is possible to monitor the effective energy emitted from the laser beam oscillator, with which an object to be machined is irradiated, and the oscillation state without affecting the properties of the laser beam.

It is also possible to maintain the conditions of the effective energy with which an object to be machined is irradiated and automatically detect and notify a situation in which maintenance is necessary.

The arithmetic control section performs real-time monitoring of the passage of the laser beam, or the magnitude thereof, based on receiving the output of the optical detection sensors.

As the arithmetic control section performs a predetermined arithmetic process and displays the result on a display section on receiving the output of the optical detection sensor, it is possible to perform real-time monitoring of the passage of the laser beam, or the magnitude of the laser beam output.

The arithmetic control section monitors whether there are troubles in the laser beam transmission path or monitors the effective energy with which an object to be machined is irradiated on receiving the output of the optical detection sensor.

Moreover, it is also possible to monitor whether there are troubles in the laser beam transmission path and to monitor the effective energy, with which an object to be machined is irradiated, when the arithmetic control section receives the output of the optical detection sensor.

The arithmetic control section adjusts the strength of a laser beam based on the result of a comparison made between the output of the optical detection sensor and the standard value of the optical detection sensor output stored in advance in a storage means.

As the arithmetic control section compares the output of the optical detection sensor with the standard value of the optical detection sensor stored in advance in a store means, it is possible to adjust the strength of the laser beam to an optimum value based on the comparison result.

It is preferable that a lens protection glass for shutting off the molten scattering objects produced at the object to be machined be provided between the object to be machined and the machining condenser lens.

As the lens protection glass is arranged between the machining condenser lens and the object to be machined, it is possible to prevent molten scattering objects from adhering to the machining convergent lens.

### BRIEF DESCRIPTION OF THE DRAWINGS

The features and advantages of the invention will be more clearly understood from the following description taken in conjunction with the accompanying drawings, in which:

FIG. 1 is a diagram showing the conventional principles of detection by laser beams;

FIG. 2 is a flow chart showing the principles of the present invention;

FIG. 3 is a diagram showing a configuration based on the principles of the present invention;

FIG. 4 is a diagram showing how an optical detection sensor detects scattered laser beams;

FIG. 5 is a diagram showing an example of observation of the laser beam oscillation state by the scattered beams;

FIG. 6 is a diagram showing monitoring of oscillation pulse waveforms;

FIG. 7 is a diagram showing the contents to be monitored and contents that can be judged depending on the positions of measurement and the differences between positions; and

FIG. 8 is a block diagram showing an example of an entire configuration of a system according to the present invention.

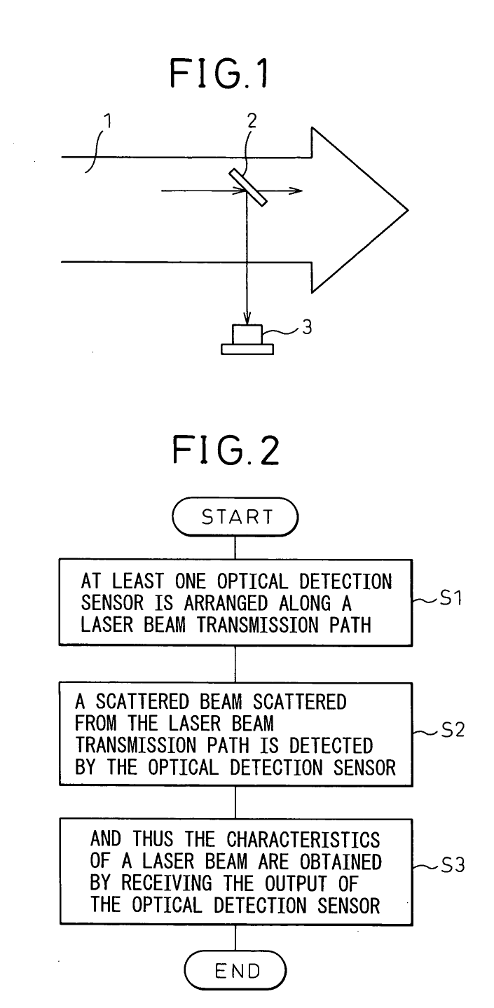

### DESCRIPTION OF THE PREFERRED EMBODIMENTS

FIG. 2 is a flow chart showing the principles of the method according to the present invention. The present invention is characterized in that at least one optical detection sensor is arranged along a laser beam transmission path (S1), a scattered beam scattered from the laser beam transmission path is detected by the optical detection sensor (S2), and thus the characteristics of a laser beam are obtained (S3) by receiving the output of the optical detection sensor.

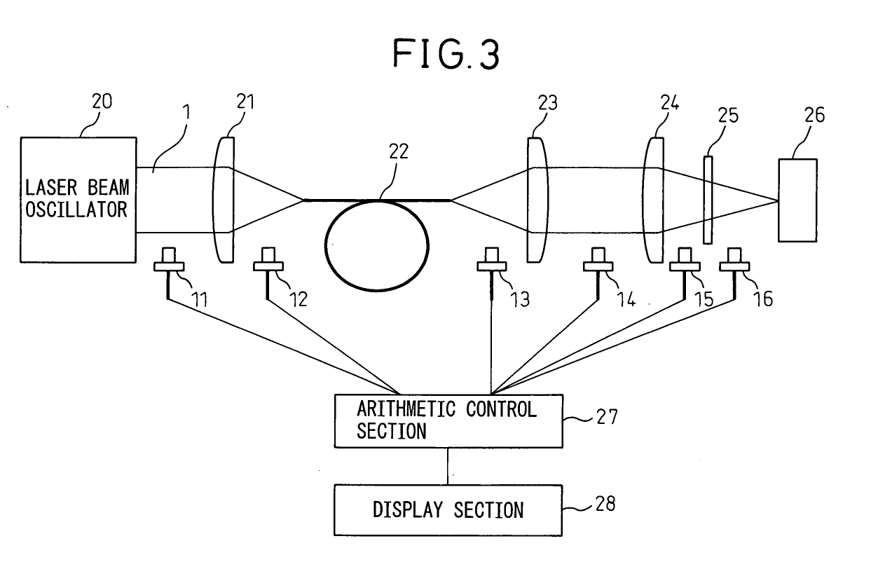

FIG. 3 is a diagram showing a configuration based on the principles of the present invention. In the figure, reference numeral 20 denotes a laser beam oscillator that produces laser beams, 1 denotes the laser beam produced by the laser beam oscillator 20, 21 denotes a condenser lens for guiding beams into an optical fiber, which receives the laser beams 1 and gathers and guides the beams into an optical fiber, 22 denotes an optical fiber as a laser beam transmission path that transmits a laser beam produced by the laser beam oscillator 20, 23 denotes a collimator lens for obtaining parallel beams by receiving the laser beams emitted from the optical fiber 22, and 24 denotes a machining condenser lens for receiving the output of the collimator lens 23 and gathering the laser beams onto an object to be machined. The laser beam transmission path means, in a broad sense, an optical transmission path extending from the laser beam oscillator 20 to an object to be machined. Reference numeral 25 denotes a lens protection glass for shutting off molten scattering objects produced at the object to be machined during the period of laser beam irradiation, and 26 denotes an object to be machined by the laser beam.

Reference numerals 11 to 16 denote optical detection sensors provided along the laser beam transmission path, 27 denotes an arithmetic control section for obtaining the characteristics of the laser beam by performing a predetermined process on receiving the output of the optical detection sensors 11 to 16, and 28 denotes a display section for displaying the state of the laser. A microprocessor, for example, is used as the arithmetic control section 27. For example, a liquid crystal display section, a CRT, a plasma display, etc. is used as the display section 28. FIG. 3 shows an example in which a plurality of optical detection sensors are arranged, but the basic characteristics of the laser beam can be obtained if there is at least one optical detection sensor.

The laser beam 1 is emitted from the laser beam oscillator 20. The emitted laser beam 1 is gathered by the following condenser lens 21 to be focused onto an input face of the optical fiber 22 and enters the optical fiber. The laser beam having passed through the optical fiber 22 is emitted from the optical fiber 22 into the collimator lens 23. The collimator lens 23 makes the scattered beams, emitted from the optical fiber 23, parallel beams.

The laser beams made parallel by the collimator lens 23 enter the machining condenser lens 24. The machining condenser lens 24 gathers the parallel beams and the object to be machined 26 is irradiated therewith. By the irradiation of the laser beams, the object to be machined 26 undergoes processes such as drilling, cutting, welding, and thermal treatment. In this case, as the lens protection glass 25 is arranged between the machining condenser lens 24 and the object to be machined 26, it is possible to prevent molten scattering objects produced at the object to be machined 26 from adhering to the machining condenser lens 24.

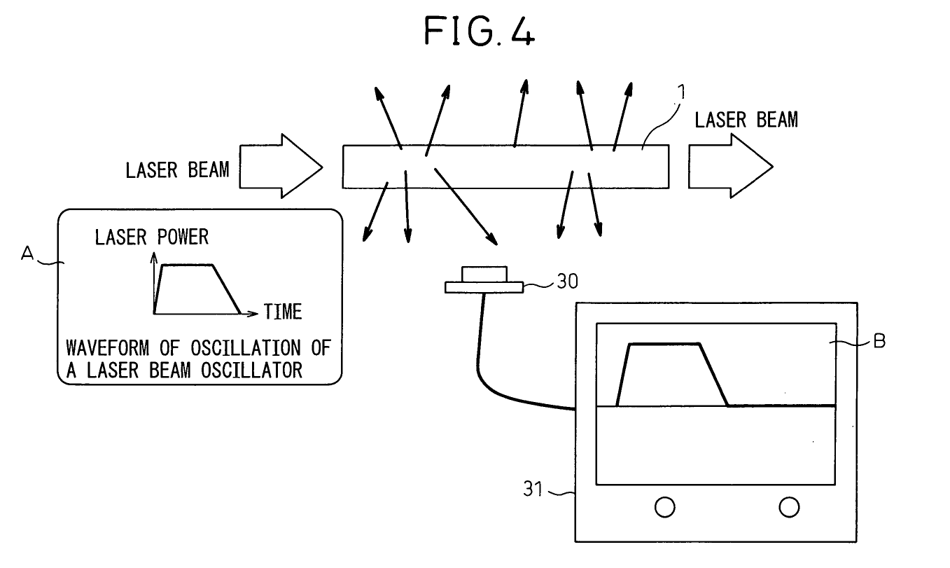

During the period of such a series of laser beam machining processes, each of the optical detection sensors 11-16 monitors the scattered laser beams at each installation position. FIG. 4 is a diagram showing how the optical detection sensor detects the scattered laser beams. The same letters or numerals are assigned to the same ones as those in FIG. 3. It is assumed that the laser beam 1 travels as shown schematically. At this time, the output waveform of the laser beam oscillator 20 (refer to FIG. 3) is assumed to be as one shown by A. The vertical axis represents laser beam power and the horizontal axis represents time. The laser beam having such a waveform is emitted from the laser beam oscillator 20. At this time, the laser beam 1 produces scattered beams X that scatter in random directions with respect to the direction in which the laser beam passes. The scattered beams X are detected by an optical detection sensor 30. The optical detection sensor 30 corresponds to each of the respective optical detection sensors 11-16 shown in FIG. 3.

A PD (photo diode) is used, for example, as the optical detection sensor 30. Then, the optical detection sensor 30 is adapted so as to detect (monitor) the scattered beams X in the direction of about 90 degrees with respect to the direction in which the laser beam passes. The signals detected by the optical detection sensor 30 are converted into electric signals and observed, on an oscilloscope 31, as a waveform B substantially the same as the oscillation waveform A of the laser beam oscillator 20.

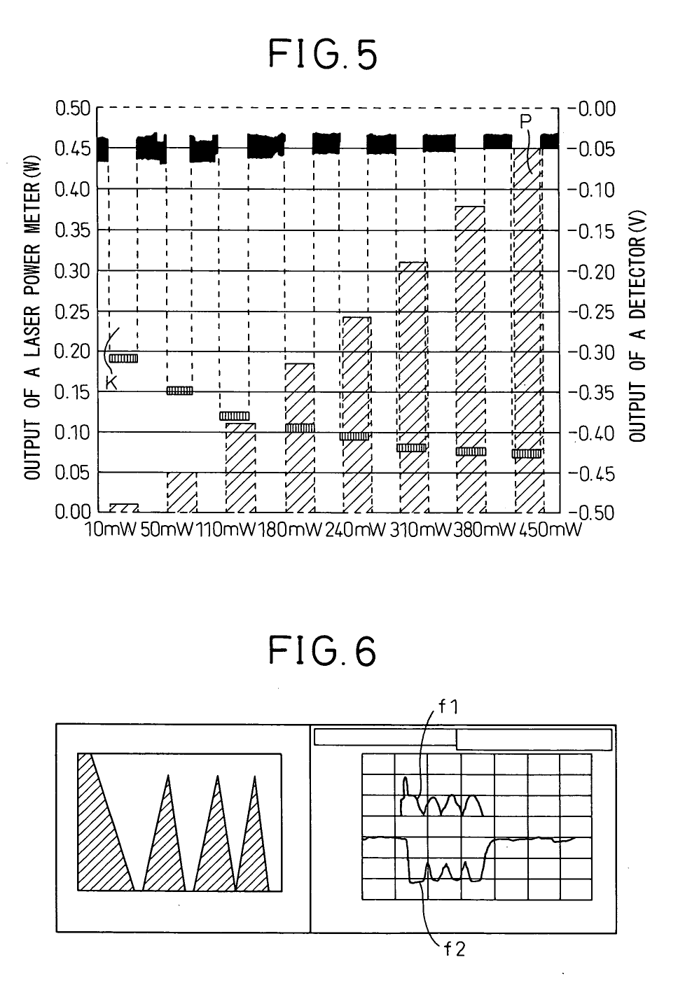

FIG. 5 and FIG. 6 are diagrams showing a case where monitoring of the state of laser beam oscillation is performed by a method according to the present invention. FIG. 5 is a diagram showing an example of observation of the laser beam oscillation state by the scattered beams. In the figure, the horizontal axis represents the output of a power meter and the vertical axis represents the output of a power meter (W) and the output of an optical detector (V). This figure shows the measured values of the power meter and the measured values of the optical detection sensor (detected outputs), respectively, when a laser beam oscillator of continuous oscillation type is used and only the output is varied while the oscillation time is maintained constant. P shows the power meter output waveform (shown by hatching) and K shows the output of the optical detection sensor, respectively.

In the figure, the output P of the power meter is obtained by directly measuring the power of the laser beam and the output K of the optical detection sensor represents the strength of the scattered beam measured simultaneously by the optical detection sensor. If the power of the laser beam is raised, the output of the power meter increases linearly as shown by P. In contrast to this, the output K of the optical detection sensor represents a saturated state to a certain degree in the high output region, but it can be said that the output K also increases substantially in proportion to the power meter output. Therefore, it is possible that measurement can be conducted using the output of the optical detection sensor instead of measuring the beam power using the beam power meter.

FIG. 6 is a diagram showing the monitoring of the oscillation pulse waveform. The figure on the left side shows a set waveform and the figure on the right side shows a power supply waveform f1 and an optical sensor monitored waveform f2 corresponding thereto. In this case, the results of the inspection of the pulse waveform can be confirmed by monitoring the scattered beams using a pulse oscillation YAG laser equipped with a pulse waveform control function. In this figure, the three waveforms are shown: the pulse waveform (shown by hatching) set using a pulse waveform setting display; the power supply waveform f1 of the laser beam oscillator at this time; and the strength f2 of the scattered beam monitored by the optical detection sensor. The power supply waveform f1 and the optical sensor monitored waveform f2 are very similar to each other. As described above, it is found that a waveform quite similar to the power supply waveform can be observed by monitoring the scattered beams.

The optical detection sensor 11 is arranged between the laser beam oscillator 20 and the condenser lens 21 for guiding beams into an optical fiber, the optical detection sensor 12 is arranged between the condenser lens 21 for guiding beams into an optical fiber and the optical fiber 22, the optical detection sensor 13 is arranged between the optical fiber 22 and the collimator lens 23, the optical detection sensor 14 is arranged between the collimator lens 23 and the machining condenser lens 24, the optical detection sensor 15 is arranged between the machining condenser lens 24 and the lens protection glass 25, and the optical detection sensor 16 is arranged between the lens protection glass 25 and the object to be machined 26.

Now, the explanation with reference to FIG. 3 is resumed. The optical detection sensors 11 to 16 produce the respective detection outputs during the period of laser beam machining to the arithmetic control section 27. The arithmetic control section 27 performs necessary arithmetic processes based on the outputs of the respective optical detection sensors 11 to 16 which the arithmetic control section has received and displays the result on the display section 28 as occasion demands.

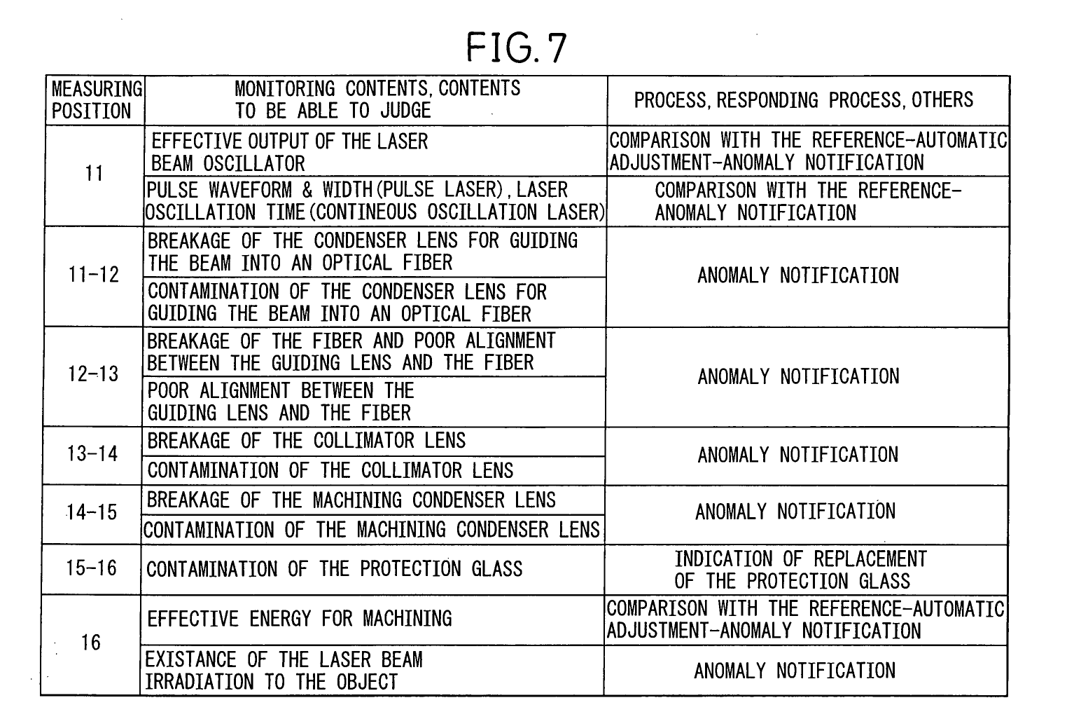

FIG. 7 is a diagram showing the contents to be monitored and the contents that can be judged depending on the positions of measurement and the differences between the positions. It is assumed that the reference numerals denoting the optical detection sensors 11 to 16 are used as the symbols representing the positions of measurement. It is possible to monitor at all times the state of the laser beam oscillator and the transmission optical system incorporated in the laser beam machine by monitoring the contents of the respective optical detection sensors 11 to 16. The contents that can be confirmed by the respective optical detection sensors and the contents that can be judged based on the differences between the sensor outputs before and after each of the optical components are explained below.

1. Optical detection sensor 11 (installed immediately after the laser beam oscillator)

(i) Whether the laser beam oscillator 20 has produced according to the instruction sent from the arithmetic control section 20 is confirmed.

(ii) Monitoring of the effective output of the laser beam oscillator 20

(iii) Pulse width and pulse waveform when a pulse laser is used.

(iv) Laser oscillation time when a continuous oscillation laser is used.

In this case, possible actions and measures include an automatic adjustment and notification of anomaly based on the comparison with the standard value, notification of anomaly based on the comparison with the standard value, etc.

2. Measurement of difference between the optical detection sensors 11 and 12

Breakage or contamination of the condenser lens 21 for guiding the beam into an optical fiber

In this case, possible actions and measures include notification of anomaly.

3. Measurement of difference between the optical detection sensor 12 and the optical detection sensor 13 Breakage of the optical fiber 22 or poor center alignment between the lens for guiding beams into an optical fiber and the optical fiber

In this case, possible actions and measures include notification of anomaly.

4. Measurement of difference between the optical detection sensor 13 and the optical detection sensor 14

Breakage or contamination of the collimator lens 23

In this case, possible actions and measures include notification of anomaly.

5. Measurement of difference between the optical detection sensor 14 and the optical detection sensor 15

Breakage or contamination of the machining condenser lens

In this case, possible actions and measures include notification of anomaly.

6. Measurement of difference between the optical detection sensor 15 and the optical detection sensor 16

Contamination of the lens protection glass 25

In this case, possible actions and measures include replacement of the protection glass.

7. Optical detection sensor 16

Monitoring of the effective energy for machining

Whether the object to be machined 26 has been irradiated with a laser beam according to the instruction sent from the arithmetic control section 27 is confirmed.

Measurement of the effective energy for machining

It is possible for the arithmetic control section 27 to adjust the power of the laser beam to an optimal value by calculating the difference from the standard value, as described above, and, at the same time, to display the output of the optical detection sensor on the display section 28 as it is.

In this case, possible actions and measures include an automatic adjustment and notification of anomaly based on the comparison with the standard value, and notification of anomaly in the case where the presence or absence of the laser beam irradiation is concerned.

As described above, according to the present invention, the optical detection sensor is adapted so as to detect the scattered beams scattered from the laser beam transmission path and, therefore, it is possible for the optical detection sensor to detect the state of the laser beam without affecting the properties of the laser beam. Therefore, according to the present invention, it is possible to monitor: the effective energy emitted from the laser beam oscillator 20, with which the object to be machined 26 is irradiated; and the oscillation state without affecting the properties of the laser beam. It is also possible to maintain the conditions of the effective energy with which the object to be machined 26 is irradiated and to automatically detect and indicate a situation in which maintenance is necessary.

Moreover, according to the present invention, the arithmetic control section 27 receives the output of the optical detection sensor, performs a predetermined arithmetic process, and displays the result on the display section 28, therefore, it is possible to perform real-time monitoring as to whether a laser beam has passed through or the magnitude of the output.

In the present invention, it is possible for the arithmetic control section 27 to monitor: whether there are troubles in the laser beam transmission path; and the effective energy with which the object to be machined 26 is irradiated by receiving the output of the optical detection sensor.

Moreover, according to the present invention, the standard values of the effective energy for machining, the pulse waveform, the irradiation time, etc., are stored in advance in a store means as the machining conditions, under which products of high quality can be obtained, and the monitored values are compared with the standard values at all times, therefore, it is possible to control the laser beam machine and the quality of machining and, at the same time, to automatically maintain and control the optimum conditions by supplying the feedback on the comparison results to the laser beam oscillator 20. In other words, as the arithmetic control section 27 compares the output of the optical detection sensor with the standard value of the optical detection sensor stored in advance in a store means, it is possible to adjust the strength of the laser beam to an optimum value based on the comparison results.

Still moreover, by judging which optical detection sensor has detected troubles, it is possible to specify the part of the laser beam transmission path at which the troubles exist and therefore to take immediate measures.

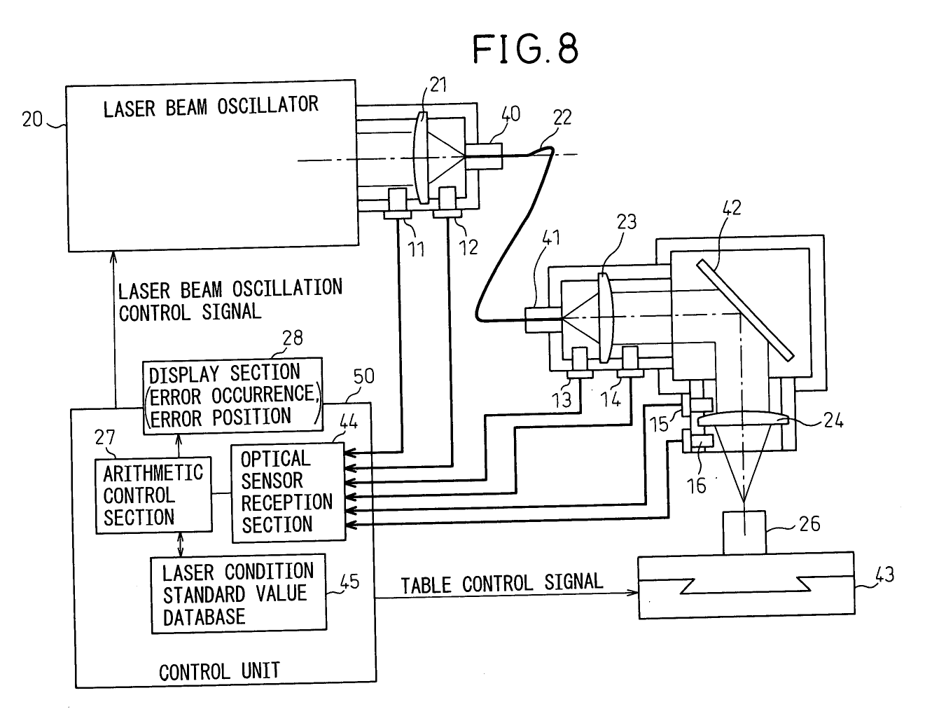

FIG. 8 is a block diagram showing an example of an entire configuration of a system according to the present invention. The same letters or numerals are assigned to the same components as those in FIG. 3. In the figure, numeral 20 denotes the laser beam oscillator. Numeral 21 denotes the condenser lens for gathering and guiding the outputs from the laser beam oscillator 20 into an optical fiber, and 40 denotes an optical fiber connector for guiding the output beams from the condenser lens for guiding beams into an optical fiber into the optical fiber 22. Numeral 22 denotes the optical fiber for transmitting the laser beam and 41 denotes an optical fiber connector for guiding the laser beam emitted from the optical fiber 22 into the collimator lens 23.

Numeral 23 denotes the collimator lens for receiving the beams emitted from the optical fiber 22 to obtain parallel laser beams, 42 denotes a bending mirror for bending the laser beam emitted from the collimator lens 23 through 90 degrees, 24 denotes the machining condenser lens for receiving the laser beam from the bending mirror 42 and gathering the laser beam on the object to be machined 26, 26 denoted the object to be machined, and 43 denotes a table for placing and moving the object to be machined 26 in a three-dimensional direction (in the x, y, and z directions).

Numeral 50 denotes a control unit for controlling the entire operation of the system. In the control unit 50, numeral 44 denotes an optical sensor reception section for receiving the outputs of the optical detection sensors 11 to 16 arranged in the laser beam transmission path, 45 denotes a laser condition standard value database in which the standard values of the laser beam conditions are stored, and 27 denotes the arithmetic control section for receiving the output from the optical sensor reception section 44 and performing a predetermined process to obtain the characteristics of a laser beam. As the arithmetic control section 27, a microprocessor is used, for example. Numeral 28 denotes the display section that is connected to the arithmetic control section 27 and which displays errors that have occurred, the place where the errors have occurred, etc. As the display section 28, the above-mentioned liquid crystal display, CRT, plasma display, etc., is used.

A laser beam oscillation control signal is output from the control unit 50 to the laser beam oscillator 20 and a table control signal is output to the table 43. Numerals 11 to 16 denote the optical detection sensors arranged at the respective positions in the laser beam transmission path. As the optical detection sensor, a solar battery, a photodiode, etc. is used, for example. The operations in the system configured in the above-mentioned manner are as follows.

The laser beam oscillator 20 is driven by the laser beam oscillation control signal output from the control unit 50 and emits laser beams. After being gathered by the condenser lens 21 for guiding beams into an optical fiber, the emitted laser beams enter the optical fiber 22 via the optical fiber connector. The laser beams having passed through the optical fiber 22 enter the collimator lens 23 via the optical fiber connector 41. The collimator lens 23 converts the incident beams into parallel beams. The laser beams emitted from the collimator lens 23 are bent through 90 degrees by the following bending mirror 24 and enter the machining condenser lens 24. The machining condenser lens 24 gathers the incident beams so as to focus on the object to be machined 26. Due to this, various processes can be performed on the object to be machined 26.

Here, the table 43 receives the table control signal from the control unit 50 and travels a predetermined distance in three directions. For example, when a linear groove is made, the object to be machined 26 is moved in two directions.

On the other hand, during the period of such a series of operations, the outputs of the optical detection sensors 11 to 16 enter the optical sensor reception section 44. The arithmetic control section 27 receives the output from the optical sensor reception section 44, performs various arithmetic processes shown in FIG. 7, and displays the results on the display section 28. Moreover, the arithmetic control section 27 compares the standard values of the laser beam output stored in the laser condition standard value database 45 with the values detected by the optical detection sensors 11 to 16 on receiving the optical detection signals. Then, the arithmetic control section 27 sends a laser beam oscillation control signal to the laser beam oscillator 20 based on the comparison results so that the output of the laser beam oscillator 20 is an optimum value. In this case, the operations of comparison include, for example, provision of feedback so that the laser beam output standard value becomes equal to the measured value detected by the optical detection sensor.

As described above, according to the present invention, it is possible to monitor the effective energy from the laser beam oscillator, with which the object to be machined is irradiated, and the state of oscillation, without affecting the properties of a laser beam and monitoring can be performed by displaying, in real time on the display section, the characteristics of the laser beam at the position of each optical component in the laser beam transmission system. Moreover, according to the present invention, it is possible to prevent the occurrence of troubles accompanying the abnormal oscillation of the laser beam oscillator and breakage and contamination of the transmission optical system. Still moreover, it is possible to specify the part at which troubles have occurred and, therefore, to take immediate measures.

1. A method for controlling a laser beam machine, comprising:
arranging at least one optical detection sensor along a laser beam transmission path (step 1);
detecting scattered beams scattered from the laser beam transmission path by the optical detection sensor (step 2); and
obtaining the characteristics of a laser beam by receiving the output of the optical detection sensor (step 3).

2. A laser beam machine comprising:
a laser beam oscillator for producing a laser beam;
a laser beam transmission path for transmitting the laser beam produced by the laser beam oscillator;
a collimator lens for receiving laser beams emitted from the laser beam transmission path to obtain parallel laser beams;
a machining condenser lens for receiving the output of the collimator lens to gather laser beams on an object to be machined;
at least one optical detection sensor provided along the laser beam transmission path; and
an arithmetic control section for receiving the output of the optical detection sensor and performing a predetermined process to obtain the characteristic of a laser beam.

3. The laser beam machine as set forth in claim 2, wherein the arithmetic control section monitors, in real time, the passage of the laser beam and the magnitude of the output based on receiving the output of the optical detection sensor.

4. The laser beam machine as set forth in claim 2, wherein the arithmetic control section monitors whether there are troubles in a laser beam transmission path and the effective energy with which an object to be machined is irradiated on receiving the output of the optical detection sensor.

5. The laser beam machine as set forth in claim 2, wherein the arithmetic control section compares the output of the optical detection sensor with the standard value of the optical detection sensor output stored in advance in a store means and adjusts the strength of the laser beam based on the comparison result.

6. The laser beam machine as set forth in claim 2, wherein a lens protection glass is provided between the object to be machined and the machining condenser lens in order to shut out molten scattering objects produced at the object to be machined.
